(19) United States
(12) Patent Application Publication
(10) Pub. No.: US 2012/0250467 A1
(43) Pub. Date: Oct. 4, 2012

(54) ESCAPEMENT MECHANISM IN PARTICULAR FOR A TIMEPIECE MOVEMENT

(75) Inventors: Kéwin BAS, VILLERS-LE-LAC (FR); Cyrille CHATEL, LA CHENALOTTE (FR)

(73) Assignee: CARTIER CREATION STUDIO S.A., GENEVA (CH)

(21) Appl. No.: 13/434,914

(22) Filed: Mar. 30, 2012

(30) Foreign Application Priority Data
Mar. 31, 2011 (CH) 00590/11

(51) Int. Cl. G04B 15/00

(52) U.S. Cl. 368/129

(57) ABSTRACT

The constant force escapement mechanism in particular for a timepiece movement including a spring balance and an escapement gear connected to a barrel by a going train includes a constant force auxiliary spring (11). It includes an impulsion lever (8) co-operating on the one hand with the escapement gear (1) and on the other hand with control members fixed to the arbor of the spring balance. The constant force auxiliary spring (11) is fixed at one of its ends on a part of the frame of the movement and at its other end to the impulsion lever (8).

The present invention relates to escapement mechanisms for a timepiece movement, in particular and more specifically to a constant force escapement mechanism.

The aim of a constant force escapement for a timepiece movement is to ensure that the oscillation of the spring balance of the movement is maintained by successive identical impulsions, i.e., providing the spring balance with the same amount of energy regardless of the winding state of the barrel of the timepiece movement.

Such constant force escapement mechanisms are known and typically comprise an auxiliary spring inserted in the kinematic chain connecting the barrel of the movement to the escapement wheel of this movement. For example, in document CH 120028 the auxiliary spring is recharged only every five oscillations of the balance such that the torque transmitted to the spring balance for each impulsion is not strictly constant since the auxiliary spring relaxes between the first and fifth impulsion.

Attempts have been made to overcome this disadvantage by devices such as that described in document EP 1319997 using a mechanism modifying the length of the lever arm with which the auxiliary spring actuates the escapement wheel. Such a mechanism is extremely complicated, cumbersome and costly.

Constant force escapement mechanisms are also known from documents EP 1528443, CH 13248 or DE 619433 in which the auxiliary springs allowing a constant torque to be transmitted to the escapement wheel are not inserted in the finishing gears of the movement but are fixed on said movement and act on a train. These mechanisms are also extremely cumbersome since they require gears which cannot be integrated in the space typically occupied by the conventional escapement mechanism, pallet fork-escapement wheel.

The aim of the present invention is to provide a constant force escapement mechanism for a timepiece movement ensuring that the spring balance is maintained by effectively identical successive impulsions and in no way modifying the finishing gears of the movement connecting its barrel to its escapement wheel which may be less cumbersome and comprise only a few parts. Another aim of the invention is to integrate the auxiliary spring of the constant force escapement mechanism in the space between the axle of the escapement wheel and the axle of the spring balance to obtain an extremely compact constant force escapement mechanism. Still another aim of the present invention is the provision of a constant force escapement mechanism having a better performance than existing ones and a reduction in the inertia of the transmission chain in particular during the transmission of the torque to the spring balance. Finally, one aim of the present invention is also to improve the chronometry of the thus equipped timepiece movement.

The present invention relates to a constant force escapement mechanism, in particular for a timepiece movement comprising a spring balance and an escapement gear connected to a barrel by a going train; this escapement mechanism comprising an auxiliary spring, characterised in that this escapement mechanism comprises an impulsion lever pivoted on one part of the frame of the movement co-operating on the one hand with the escapement gear and on the other hand with control members fixed, i.e., fixedly attached, to the arbor of the spring balance; and in that the constant force auxiliary spring is fixed at one of its ends on a part of the frame of the movement and at its other end to the axle of the impulsion lever.

The invention also relates to a timepiece movement or a timepiece whose movement is equipped with such a constant force escapement mechanism.

A particular embodiment of the constant force escapement mechanism for a timepiece movement is illustrated schematically and by way of example in the accompanying drawing, in which:

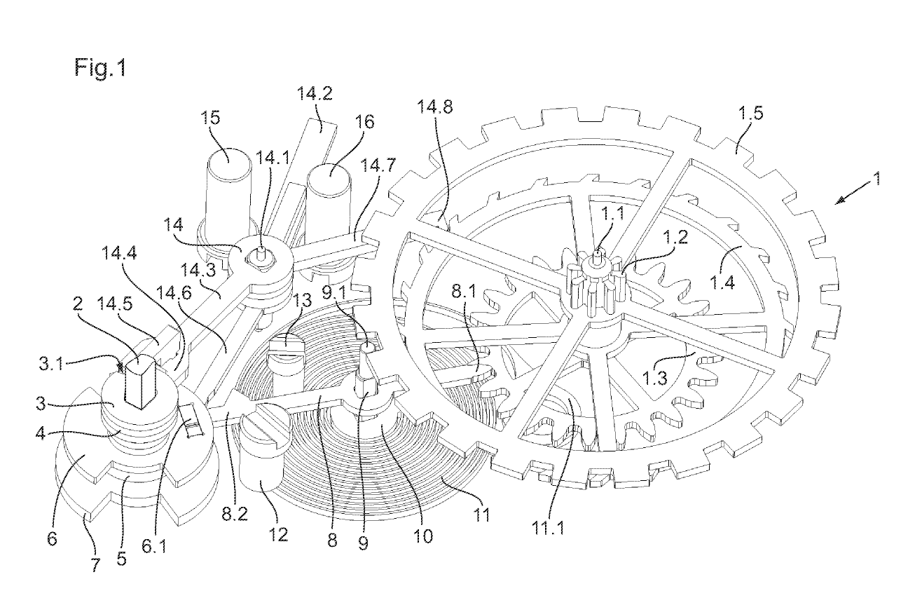

FIG. 1 is an overall perspective view of the constant force escapement mechanism,

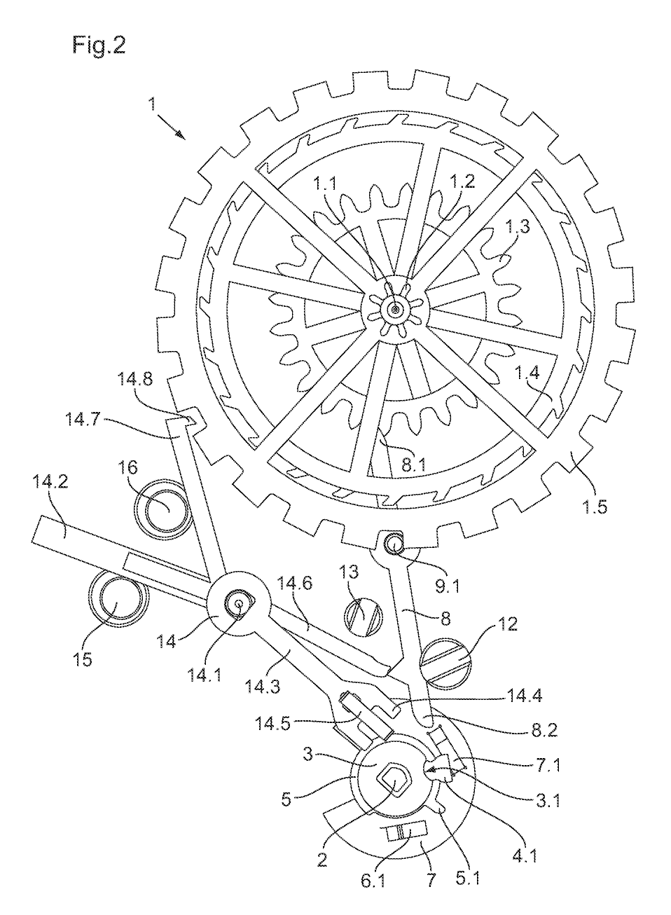

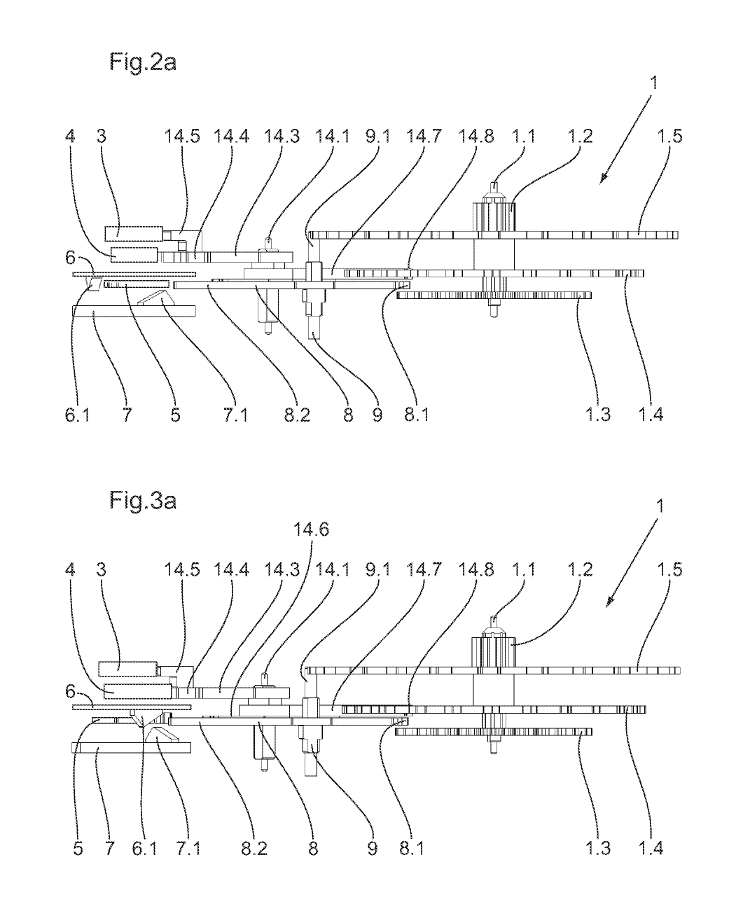

FIGS. 2 and 2a are plan and top views of the mechanism of FIG. 1 in its initial position,

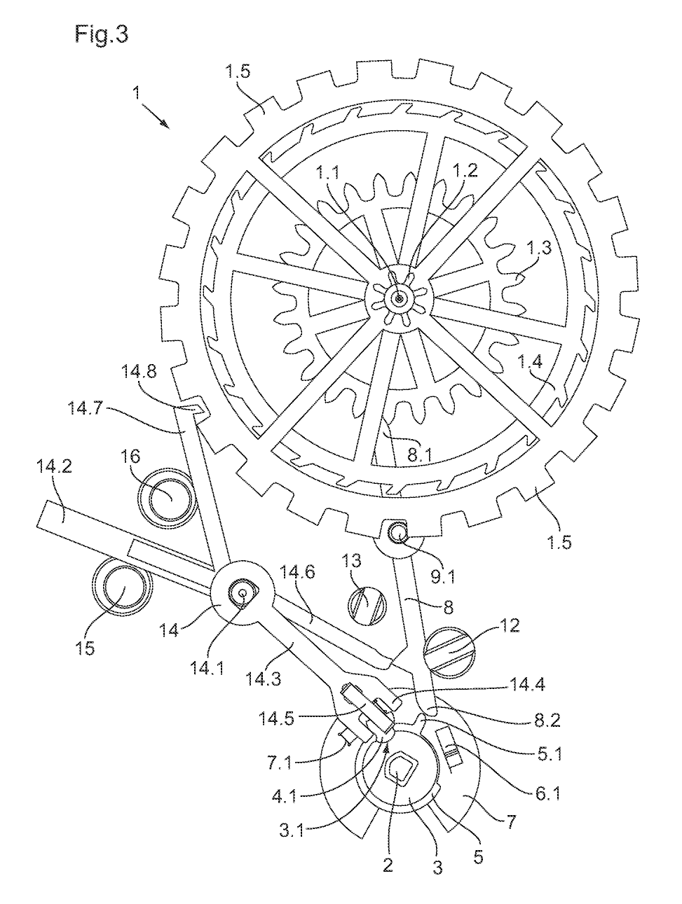

FIGS. 3 and 3a are plan and top views of the mechanism when the impulsion lever is released,

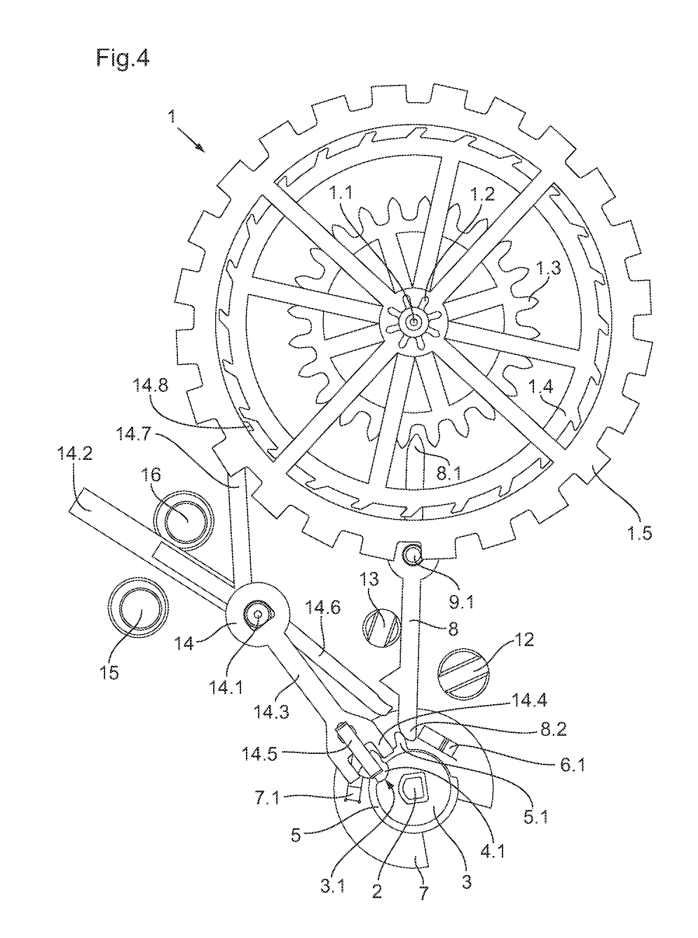

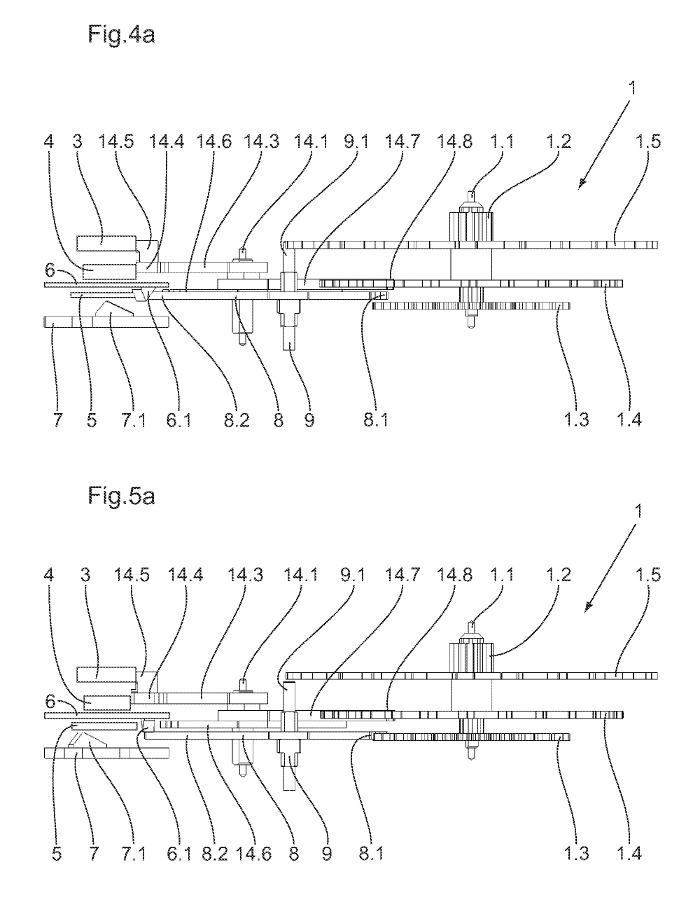

FIGS. 4 and 4a are plan and top views of the mechanism at the end of the rotation of the impulsion lever,

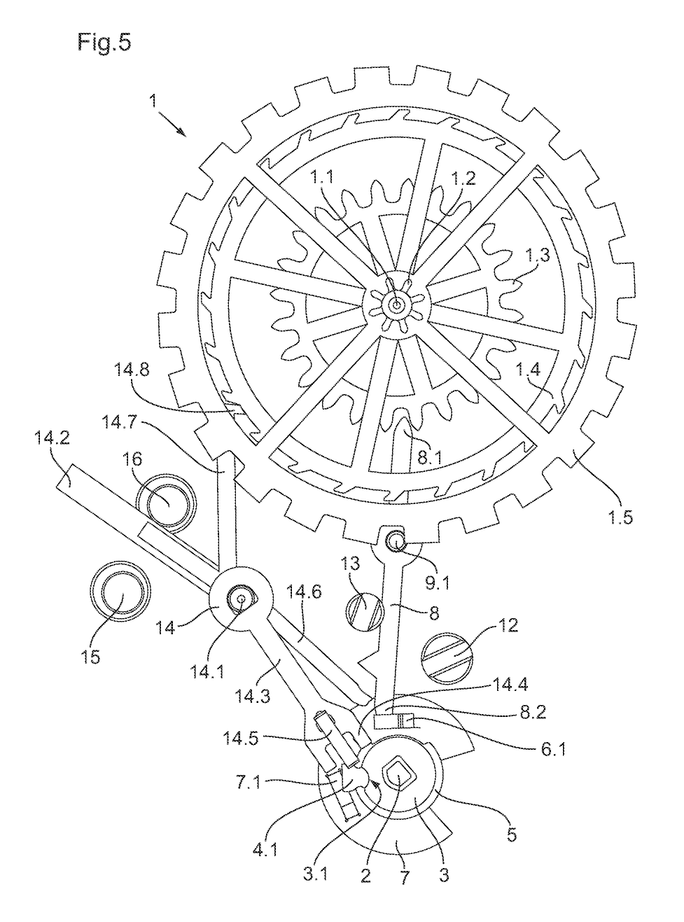

FIGS. 5 and 5a are plan and top views of the mechanism when the impulsion lever is engaged with the escapement wheel,

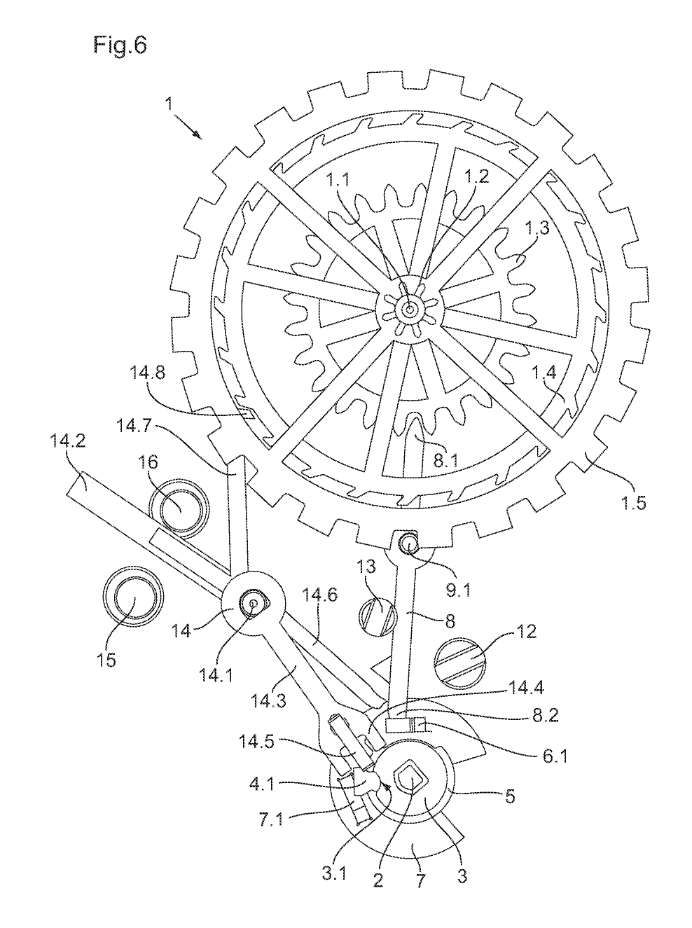

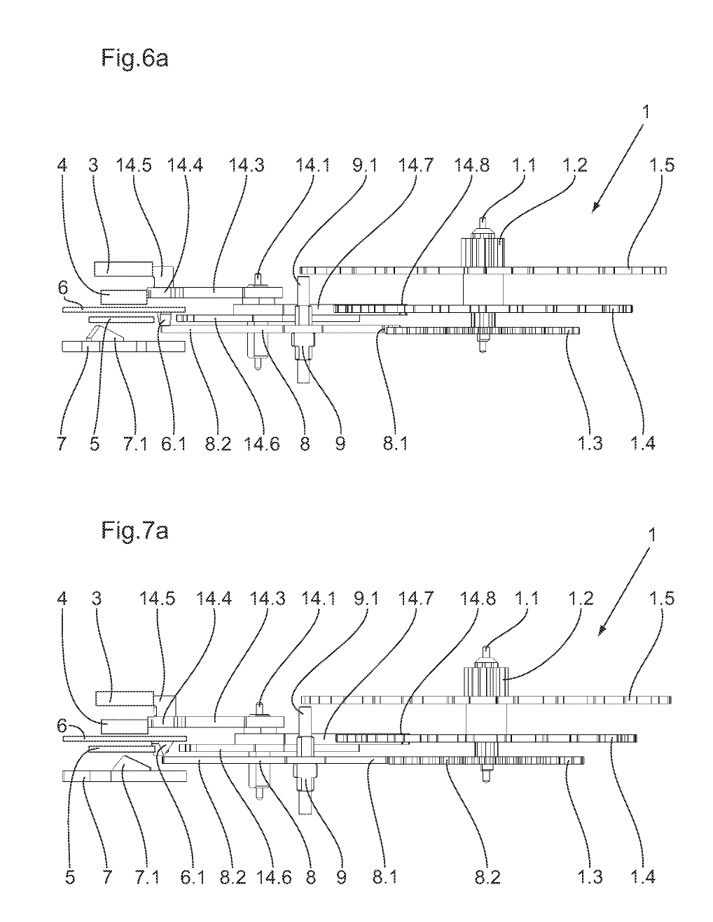

FIGS. 6 and 6a are plan and top views of the mechanism at the end of the first re-winding phase of the impulsion lever,

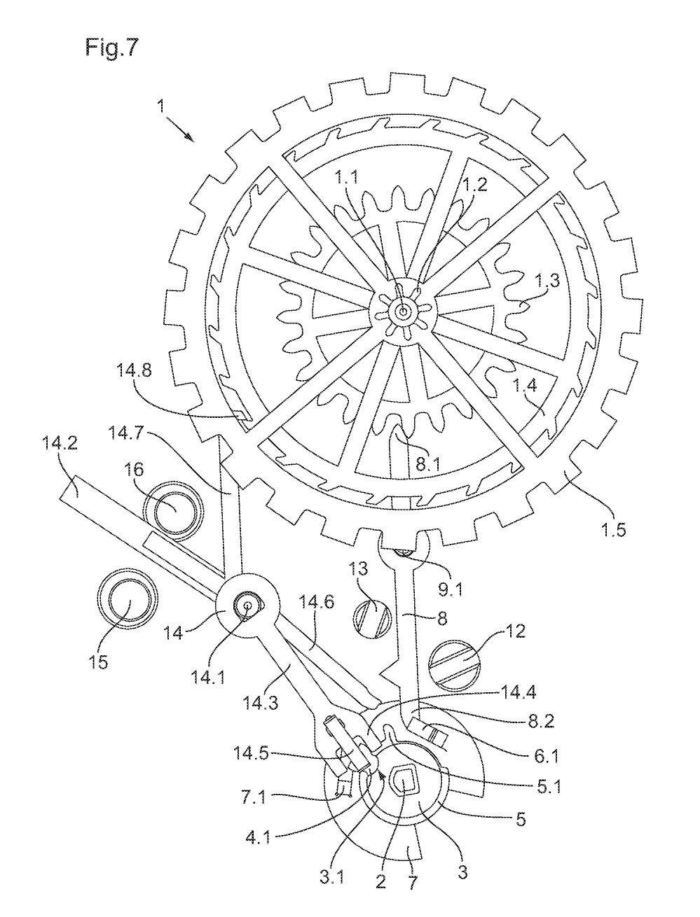

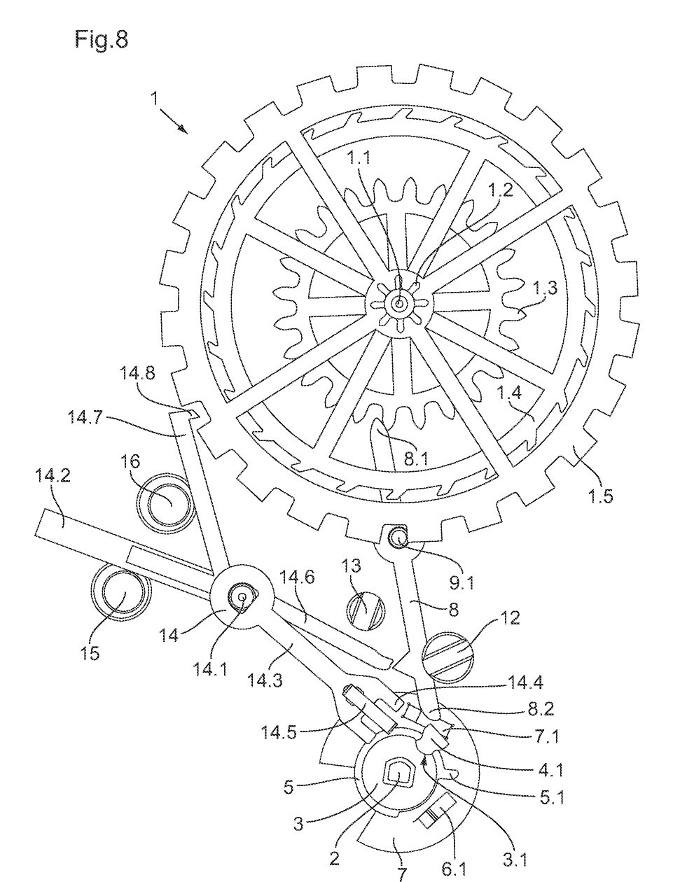

FIGS. 7 and 7a are plan and top views of the mechanism during the second re-winding phase of the impulsion lever,

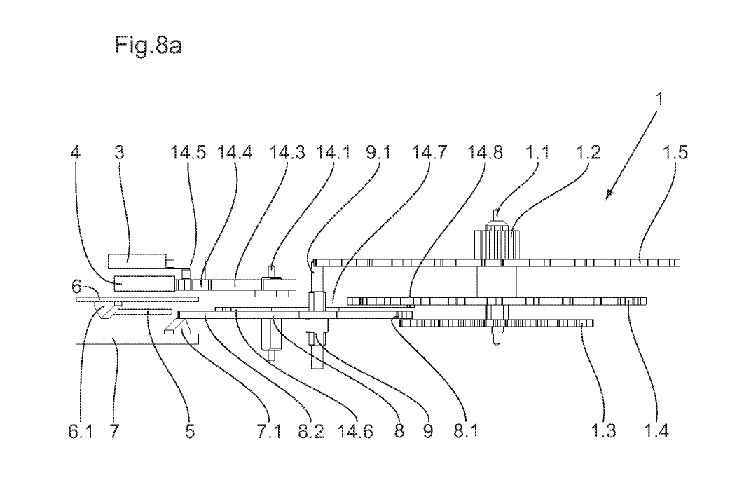

FIGS. 8 and 8a are plan and top views of the mechanism during its return to the initial position.

The Figures illustrate a constant force escapement mechanism in accordance with the invention comprising a constant force auxiliary spring and intended to be equipped in a timepiece movement comprising a spring balance and an escapement gear connected to a barrel by a going train. The distinguishing feature of this constant force escapement mechanism is that it comprises an impulsion lever pivoted on one part of the frame of the movement co-operating on the one hand with the escapement gear and on the other hand with control members fixed to the arbor of the spring balance, and that the constant force auxiliary spring is fixed at one of its ends on one part of the frame of the movement and at its other end to the axle of the impulsion lever.

In the embodiment illustrated by way of example, the constant force escapement mechanism has an escapement gear 1 comprising, mounted on an axle 1.1, an escapement pinion 1.2 connected kinematically by a going train (not shown) to the barrel (not shown) of a timepiece movement.

This escapement gear 1 further comprises a lower escapement wheel 1.3, an intermediate escapement wheel 1.4 and an upper escapement wheel 1.5, all three of which are fixed to the axle 1.1. This escapement gear 1 is pivoted on a part of the frame of the timepiece movement such as the bottom plate, a bridge or a tourbillon cage of this timepiece movement.

This escapement mechanism further comprises control members fixed to the axle 2 of the spring balance (not shown) pivoted on one part of the frame of the timepiece movement. In the illustrated example, this axle 2 of the spring balance has a guard pin safety roller 3 provided with a notch 3.1; a pin safety roller 4 having a pin 4.1 and located beneath the guard pin safety roller 3; an upper control safety roller 6 having an upper cam 6.1 on its lower surface; a lower control safety roller 7 having a lower cam 7.1 on its upper surface facing said upper control safety roller 6; and an impulsion safety roller 5 having an impulsion finger 5.1 and located between the upper control safety roller 6 and the lower control safety roller 7. These different safety rollers and the elements supported thereby or located thereon form a set of control members of the constant force escapement mechanism as explained hereinafter.

The constant force escapement mechanism further comprises an impulsion lever 8 mounted so as to be able to pivot and longitudinally slide on a part of the frame of the timepiece movement. The lever 8 is fixed to a lock axle 9 perpendicular to the plane in which the impulsion lever 8 pivots. This lock axle 9 preferably extends in parallel with the axle 2 of the spring balance and with the axle of rotation 1.1 of the escapement gear 1. This lock axle 9 is angularly fixed to a collet 10 which is itself fixed to the inner end of a constant force auxiliary spring 11 whose outer end 11.1 is provided to be fixed on a part of the frame of the timepiece movement.

In the illustrated example, the collet 10 is mounted so as to be able to slide on the lock axle 9 whilst being angularly fixed thereto (i.e., they are fixed together in rotation). In alternative embodiments, the collet 10 could be fixed to the lock axle 9 or the impulsion lever 8.

The impulsion lever 8 has a first tooth-shaped end 8.1 intended to co-operate with the teeth of an impulsion toothing arrangement of the lower escapement wheel 1.3. This impulsion lever 8 has a second end 8.2 extending between the upper control safety roller 6 and the lower control safety roller 7 which are fixed to the axle of the spring balance, which second end is intended to co-operate with the upper 6.1 and lower 7.1 cams. A first pin 12, fixed on a part of the frame of the timepiece movement, is used as a stop for the impulsion lever 8. The constant force auxiliary spring 11 tends to displace the impulsion lever 8 in the direction of a second pin 13.

The lock axle 9 supporting the impulsion lever 8 is able to be displaced longitudinally between a top position in which its locking end 9.1 co-operates with a first locking toothing arrangement of the upper escapement wheel 1.5 and prevents any rotation thereof, and a bottom position in which the upper escapement wheel 1.5 is released from the locking end 9.1 of this lock axle 9.

The constant force escapement mechanism further comprises a locking lever 14 having four arms fixed to a locking lever axle 14.1 pivoted on a part of the frame of the timepiece movement. This locking lever 14 has a first arm 14.2 co-operating with a third pin 15 and a fourth pin 16 for limiting the angular displacement of the locking lever 14.

The locking lever further comprises a second arm 14.3 whose end comprises a fork 14.4 and a guard pin 14.5 intended to co-operate with the pin 4.1 or guard pin safety roller 3 respectively in the manner of a conventional Swiss lever escapement for controlling the angular displacements of the locking lever 14, this locking lever 14 further has a third arm 14.6 whose free end is used as a holding stop for the impulsion lever 8 in the wound position against the first pin 12.

Finally, this locking lever 14 has a fourth arm 14.7 whose end has a hook 14.8 intended to co-operate with a second locking toothing arrangement of the intermediate escapement wheel 1.4.

Starting from the initial position of this constant force escapement mechanism illustrated in FIGS. 2, 2a, the operation of this mechanism will be described hereinafter.

In the initial position illustrated in FIGS. 2, 2a, the escapement gear 1 is locked by the end 9.1 of the lock axle 9 which is in the top position. The impulsion lever 8 is also in the top position in which its first end 8.1 is located above the plane of the lower escapement wheel 1.3 and therefore does not co-operate therewith.

The impulsion lever 8 is subjected to the action of the torque of the constant force auxiliary spring 11 which tends to rotate it in the clockwise direction (in the view of the Figures). The impulsion lever 8 is locked by the end of the third arm 14.6 of the locking lever. The impulsion lever 8 subjected to the action of the constant force auxiliary spring 11 pushes the end of the third arm 14.6 of the locking lever 14 which holds it in abutment against the third pin 15 by its second arm 14.2. The guard pin 14.5 and the guard pin safety roller 3 prevent any untimely unlocking of the mechanism.

The balance rotates in the anti-clockwise direction driving the pin 4.1 of the pin safety roller 4 into the fork 14.4 of the locking lever 14 causing the displacement of this locking lever in the clockwise direction until its second arm 14.2 abuts against the fourth pin 16 (FIGS. 3, 4). The impulsion lever 8 is released but the escapement gear 1 is still locked by the lock axle 9.

The released impulsion lever 8 is displaced in the clockwise direction under the effect of the constant force auxiliary spring 11. The second end 8.2 of the impulsion lever at the level of the impulsion safety roller 5 contacts the impulsion finger and transmits the energy to the balance until the impulsion lever 8 reaches the second pin 13. Thus, the energy is transmitted until the impulsion lever 8 stops and there is therefore no lost travel on the part of the impulsion lever.

The inclined plane of the upper cam 6.1 of the upper safety roller 6 causes the descent of the lever 8 whose first end 8.1 is housed between two teeth of the impulsion toothing arrangement of the lower escapement wheel 1.3. During the descent, the impulsion lever drives the lock axle 9 until it reaches its bottom position thereby releasing the escapement gear as soon as the end 9.1 of the lock axle escapes the first locking toothing arrangement of the upper escapement wheel 1.5 (FIG. 5).

In the illustrated embodiment, the collet 10 can move with the lock axle 9 since the energy of the spring used during the rise/descent of this lock axle is not significant. However, in one alternative embodiment, the collet can remain in the same plane using a sliding link with the lock axle 9.

Having been released, the escapement gear 1 rotates in the anti-clockwise direction, in so doing the impulsion toothing arrangement of the lower escapement wheel 1.3 drives the impulsion lever 8 in the clockwise direction against the action of the constant force auxiliary spring 11 until the escapement gear is locked by the hook 14.8 of the fourth arm 14.7 of the locking lever located in the path of the second locking toothing arrangement of the intermediate escapement wheel 1.4 (FIG. 6). The going train and the escapement gear 1 are thus locked by the locking lever 14 and the intermediate escapement wheel 1.4. The impulsion lever 8 is also prevented from rotating by the lower escapement wheel 1.3. The locking lever 14 is held against the pin 15 owing to the force of the intermediate escapement wheel 1.4 on the fourth arm 14.7 of this locking lever 14. (The orientation of the force is considered as in the case of a conventional Swiss lever escapement between the lever and the escapement.) The guard pin 14.5 and the guard pin safety roller 3 prevent any untimely unlocking. The balance completes its half-path.

Subsequently, the balance reverses its direction of rotation. The pin 4.1 of the pin safety roller co-operates with the fork of the second arm 14.3 of the locking lever (like in a conventional Swiss lever escapement) which releases the escapement gear 1, the hook 14.8 of the fourth arm of the locking lever escapes the toothing arrangement of the intermediate escapement wheel 1.4 (FIG. 7).

The thus released escapement gear 1 resumes its clockwise rotation and the impulsion toothing arrangement of the lower escapement wheel 1.3 drives the first end 8.1 of the impulsion lever re-winding the constant force auxiliary spring 11 until the impulsion lever abuts against the first pin 12 (FIG. 8).

The inclined plane of the lower cam 7.1 of the lower control safety roller 7 causes the impulsion lever 8 to rise again, disengaging it from the lower escapement wheel 1.3. In so doing, the lock axle 9 is also raised and its locking end 9.1 is housed between two teeth of the locking toothing arrangement of the upper escapement wheel 1.5 locking the escapement gear 1 and the going train (FIG. 8). The end of the third arm 14.6 of the locking lever 14 locks the impulsion lever 8 and the mechanism is back in its initial position (FIG. 2).

This novel constant force escapement mechanism is simple, it does not have many parts, and in particular has fewer parts than existing constant force escapements. The cumbersomeness of the constant force escapement mechanism is reduced owing to the low number of parts thereof and owing to the fact that the auxiliary spring is housed, incorporated, between the axle 2 of the balance and the axle 1.1 of the escapement gear.

In the embodiment described above, the constant force escapement mechanism has the feature of having separated the function of locking the escapement gear 1 which is effected by the lock axle 9 and the fourth arm 14.7 of the locking lever and the impulsion function which is effected using the impulsion lever 8 and the constant force auxiliary spring. This particular embodiment (which is also the subject of another patent application by the Applicant filed on the same day as this one) has further advantages since during the impulsion phase the escapement gear 1, and thus the entire going train of the movement, is locked such that the inertia of the moving parts during impulsion is very low, thus preventing any recoil of the escapement gear 1. Moreover, all of the angular travel of the impulsion lever is effectively active, without any lost travel in this embodiment. Owing to these arrangements, the performance of the escapement mechanism is greatly improved, as is the precision of the chronometry of the movement provided with this escapement mechanism. Finally, the energy transmitted to the balance at each impulsion is strictly constant since it depends only upon the auxiliary spring which re-winds between each impulsion.

In this illustrated embodiment, the regulating member formed by the lock axle 9 is fixed to the impulsion lever 8 and is used as its pivot axle. In alternative embodiments, the regulating member could be independent of the impulsion lever 8 and controlled by another pair of cams supported by lower 7 and upper 6 control safety rollers which are fixed to the axle 2 of the balance.

In the illustrated example, the escapement gear 1 has three escapement wheels 1.3, 1.4 and 1.5 each having a toothing arrangement.

The impulsion toothing arrangement is supported by the lower escapement wheel 1.3 and co-operates with the impulsion lever 8, the second locking toothing arrangement is supported by the intermediate escapement wheel 1.4 and co-operates with the fourth arm 14.7 of the locking lever 14 and the first locking toothing arrangement is supported by the upper escapement wheel 1.5 and co-operates with the lock axle 9. The number of escapement wheels can be reduced so long as the escapement gear 1 has the three toothing arrangements co-operating with the impulsion lever 8, the locking lever 14 and the lock axle 9 respectively. These three toothing arrangements can in fact be supported by only one or two wheels.

In another variation of this embodiment of the mechanism, there is no locking lever, with the escapement gear being locked only by the lock axle fixed to the impulsion lever. In this case, the lock axle has three distinct axial positions controlled by three cams supported by the balance axle.

More generally, a constant force escapement mechanism in accordance with the present invention can take various other forms (e.g., a more conventional escapement in which the impulsion lever and the regulating member(s) move in the same plane or in mutually parallel planes. The essential feature in the present invention is that the escapement mechanism comprises an impulsion lever pivoted on the frame of the movement co-operating on the one hand with the escapement gear and on the other hand with control members fixed to the arbor of the spring balance as well as a constant force auxiliary spring, one end of which is fixed on a part of the frame of the movement and the other end of which is angularly fixed to the impulsion lever (8).

1. Constant force escapement mechanism, in particular for a timepiece movement comprising a spring balance and an escapement gear connected to a barrel by a going train; the escapement mechanism comprising a constant force auxiliary spring (11), characterised in that the escapement mechanism comprises an impulsion lever (8) pivoted on one part of the frame of the movement co-operating on the one hand with the escapement gear (1) and on the other hand with control members fixed to the arbor of the spring balance; and in that the constant force auxiliary spring (11) is fixed at one of its ends on a part of the frame of the movement and that its other end is angularly fixed to the impulsion lever (8).

2. Mechanism as claimed in claim 1, characterised in that the impulsion lever (8) is mounted on the movement so as to be angularly and axially displaceable with respect to the frame of the timepiece movement.

3. Timepiece movement as claimed in claim 1 characterised in that the constant force auxiliary spring (11) is a helical spring.

4. Timepiece movement as claimed in claim 3, characterised in that the inner end of this helical spring is fixed to a collet (10) which is angularly fixed to the impulsion lever (8) whilst its outer end is fixed on a part of the frame of the timepiece movement.

5. Timepiece movement as claimed in claim 4, characterised in that the axle of rotation of the impulsion lever forms a lock axle (9) co-operating with the escapement gear.

6. Mechanism as claimed in claim 5, characterised in that the collet (10) moves with the lock axle (9) during axial displacement of the lock axle.

7. Mechanism as claimed in claim 5, characterised in that the collet (10) is mounted so as to be able to slide on the lock axle (9).

8. Timepiece movement as claimed in claim 2 characterised in that the constant force auxiliary spring (11) is a helical spring.

9. Timepiece movement as claimed in claim 8, characterised in that the inner end of this helical spring is fixed to a collet (10) which is angularly fixed to the impulsion lever (8) whilst its outer end is fixed on a part of the frame of the timepiece movement.

10. Timepiece movement as claimed in claim 9, characterised in that the axle of rotation of the impulsion lever forms a lock axle (9) co-operating with the escapement gear.

11. Mechanism as claimed in claim 10, characterised in that the collet (10) moves with the lock axle (9) during axial displacement of the lock axle.

12. Mechanism as claimed in claim 11, characterised in that the collet (10) is mounted so as to be able to slide on the lock axle (9).
